(19) United States
(12) Patent Application Publication
(10) Pub. No.: US 2007/0046944 A1
(43) Pub. Date: Mar. 1, 2007

(54) Method of measuring haze and apparatus thereof

(75) Inventors: Hyeon Ok Ghil, Suwon-si (KR); Jae Young Bae, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/507,476

(22) Filed: Aug. 22, 2006

(30) Foreign Application Priority Data
Aug. 23, 2005 (JP) 10-2005-0077094
Aug. 23, 2005 (JP) 10-2005-0077098

(51) Int. Cl. G01N 21/47

(52) U.S. Cl. 356/446

(57) ABSTRACT

The present invention relates to a method of measuring haze including transmitting light, generated by a light source, through a sample; converting the light, transmitted through the sample, into parallel light through a null lens; and separating the light, transmitted through the null lens, into parallel light and diffused light through an integrating sphere and then measuring haze.

### CROSS-REFERENCE TO RELATED APPLICATIONS

The application claims the benefit of Korea Patent Application No. 2005-0077094 filed with the Korea Intellectual Property Office on Aug. 23, 2005, the disclosure of which is incorporated herein by reference.

### BACKGROUND OF THE INVENTION

1. Field of the Invention

The present invention relates to a method of measuring haze and an apparatus thereof. In the method of measuring haze, it is possible to quantitatively measure haze characteristics of a sample with a curved surface, which have been evaluated only with naked eyes.

2. Description of the Related Art

In general, an apparatus for measuring haze serves to measure the transmission of light with respect to transparent materials, such as glass and plastic, as a haze value. An apparatus or method which measures an amount of light transmitted through a material, such as transparent glass, plastic, film or the like, as a haze value is already prescribed by ISO. As an example, there are provided ′ISO 7105: Method of testing optical characteristics of plastic′, ′ISO 14782: Method of measuring haze of plastic-transparent material′ and the like.

The conventional apparatuses for measuring haze can measure haze on a plane sample, but cannot measure haze on a sample with a curved surface. Therefore, in the related arts, haze on a sample with a curved surface has been evaluated only with naked eyes, which makes it impossible to satisfy the accuracy and repetition of measurement because of errors caused by a measurer.

Then, the method of measuring haze according to the related art will be examined with reference to accompanying drawings, and the problems thereof will be described.

FIGS. 1A and 1B are diagrams for explaining the method of measuring haze according to the related art. FIG. 1A is a diagram for explaining a method of measuring total transmitted light through a sample, and FIG. 1B is a diagram for explaining a method of measuring diffused light through the sample.

As shown in FIGS. 1A and 1B, a conventional apparatus for measuring haze is provided with a light source 1 which generates light, a sample 2 which receives the light generated from the light source 1, and an integrating sphere 3 which detects the light transmitted through the sample 2 so as to measure haze.

The integrating sphere 3 is provided with a first opening 3a which receives the light transmitted through the sample 2, a second opening 3b which is formed in a position opposing the first opening 3a, and a third opening 3c which is formed in a direction orthogonal to the first and second openings 3a and 3b. Further, the second opening 3b is provided with a first sensor 4a which measures parallel light of the light transmitted through the sample 2, and the third opening 3c is provided with a second sensor 4b which measures diffused light of the light transmitted through the sample 2. Here, the sample 2 on which haze is desired to be measured is a plane sample made of a transparent material such as glass or plastic.

The light generated by the light source 1 is separated into parallel light PT and diffused light DT through the sample 2 so as to be incident on the integrating sphere 3. At this time, the integrating sphere 3 detects the parallel light PT and diffused light DT, which are incident through the sample 2, so as to measure haze.

An expression for calculating the haze is represented by the ratio of the parallel light (total transmitted light) PT to the diffused light DT, as described in the following Expression 1.

$$Haze ( \% ) = \frac{diffused light}{total transmitted light} \times 100 \qquad [ Expression 1 ]$$

Therefore, if the ratio of the parallel light PT to the diffused light DT can be known, it is possible to measure haze from Expression 1.

As shown in FIG. 1A, the parallel light PT transmitted through the sample 2 is measured using the first sensor 4a installed in the second opening 3b of the integrating sphere 3. As shown in FIG. 1B, the diffused light DT transmitted through the sample 2 is measured using the second sensor 4b installed in the third opening 3c of the integrating sphere 3. The standards for measuring haze are prescribed in ISO FDIS 14782.

FIGS. 2A and 2B are diagrams for explaining the method of measuring haze on a sample with a plane surface and a sample with a curved surface according to the related art.

FIG. 2A shows a method of measuring haze of a sample 2a with a plane surface. As shown in FIG. 2A, the light transmitted through the sample 2a with a plane surface is separated into parallel light PT and diffused light DT so as to be incident on the integrating sphere 3. Therefore, if the ratio of the parallel light PT and the diffused light DT is known, it is possible to calculate haze from Expression 1. At this time, the ratio of the parallel light PT and the diffused light DT can be detected from the first and second sensors 4a and 4b provided in the integrating sphere 3, as described above.

FIG. 2B shows a case where haze is measured using a sample 2b with a curved surface. In the case of the sample 2b with a curved surface, the light incident from the light source 1 is refracted so as to be converged or diverged while being transmitted through the sample 2b with a curved surface. Therefore, only converged or diverged light is incident on the integrating sphere 3 through the sample 2b with a curved surface. Accordingly, in the case of the sample 2b with a curved surface, the light transmitted through the sample 2b with a curved surface is converged or diverged, so that parallel light PT and diffused light DT cannot be detected accurately, which makes it impossible to measure haze.

As such, although haze of a sample with a plane surface such as film can be measured in the conventional method of measuring haze and the apparatus thereof, it is impossible to accurately measure haze on a sample with a curved surface such as a lens, because the light incident on the integrating sphere is refracted.

### SUMMARY OF THE INVENTION

An advantage of the present invention is that it provides a method of measuring haze and an apparatus thereof, in which a null lens is added between a sample with a curved surface and an integrating sphere so that the light incident on the integrating sphere through the sample is not refracted, and thus haze can be accurately measured regardless of the shape of a sample.

Additional aspects and advantages of the present general inventive concept will be set forth in part in the description which follows and, in part, will be obvious from the description, or may be learned by practice of the general inventive concept.

According to an aspect of the invention, a method of measuring haze includes transmitting light, generated by a light source, through a sample; converting the light, transmitted through the sample, into parallel light through a null lens; and separating the light, transmitted through the null lens, into parallel light and diffused light through an integrating sphere and then measuring haze.

According to another aspect of the invention, the haze is obtained by the following expression:

$$Haze ( \% ) = \frac{diffused light}{total transmitted light} \times 100.$$

According to a further aspect of the invention, the parallel light is detected by a sensor installed in an opening of the integrating sphere which is formed in a direction where the parallel light is incident.

According to a still further aspect of the invention, the diffused light is detected by a sensor installed in an opening of the integrating sphere which is formed in a direction orthogonal to the direction where the parallel light is incident.

According to a still further aspect of the invention, as the sample, any one of a transparent plane sample, a glass lens, a plastic lens, and liquid lens is used.

According to a still further aspect of the invention, the sample is a sample with a curved surface.

According to a still further aspect of the invention, the sample with a curved surface is a concave lens.

According to a still further aspect of the invention, the sample with a curved surface is a convex lens.

According to a still further aspect of the invention, an apparatus for measuring haze includes a light source that generates light; a sample that receives the light from the light source and transmits the light; an integrating sphere that detects the light transmitted through the sample so as to measure haze; and a null lens that is positioned between the sample and the integrating sphere and converts the light, incident on the integrating sphere through the sample, into parallel light.

According to a still further aspect of the invention, the sample is any one of a transparent plane sample, a glass lens, a plastic lens, and liquid lens.

According to a still further aspect of the invention, the sample is a sample with a curved surface.

According to a still further aspect of the invention, the sample with a curved surface is a concave lens.

According to a still further aspect of the invention, the sample with a curved surface is a convex lens.

According to a still further aspect of the invention, the integrating sphere includes a first opening that receives the light transmitted through the sample; a second opening that is formed in a position opposing the first opening; a third opening that is formed in a direction orthogonal to the first and second openings; a first sensor that is installed in the second opening so as to measure parallel light of the light transmitted through the sample; and a second sensor that is installed in the third opening so as to measure diffused light of the light transmitted through the sample.

Therefore, in the present invention, it is possible to accurately measure haze using a null lens or liquid lens, regardless of the shape of a sample.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are diagrams for explaining a method of measuring haze according to the related art, FIG. 1a being a diagram for explaining a method of measuring total transmitted light through a sample and FIG. 1b being a diagram for explaining a method of measuring diffused light through a sample;

FIGS. 2A and 2B are diagrams for explaining a method of measuring haze on a sample with a plane surface and a sample with a curved surface according to the related art;

FIGS. 3 and 4 are diagrams for explaining a method of measuring haze according to the present invention, FIG. 3 being a diagram for explaining a method of measuring total transmitted light through a sample and FIG. 4 being a diagram for explaining a method of measuring diffused light through a sample; and

FIGS. 5 and 6 are diagrams for explaining another method of measuring haze according to the invention, FIG. 5 being a diagram for explaining a diagram for explaining a method of measuring total transmitted light through a sample using a liquid lens and FIG. 6 being a diagram for explaining a method of measuring diffused light through a sample using a liquid lens.

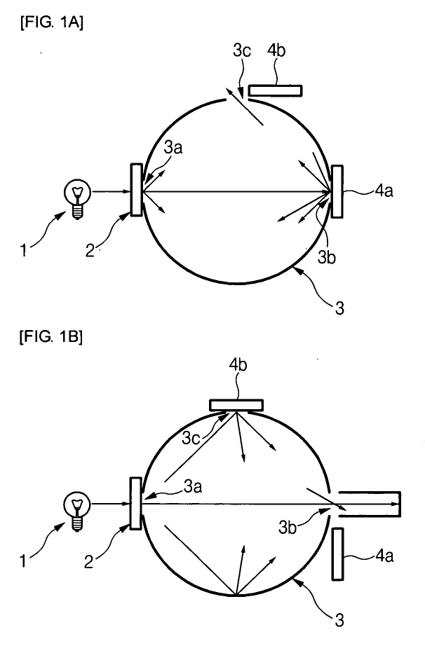

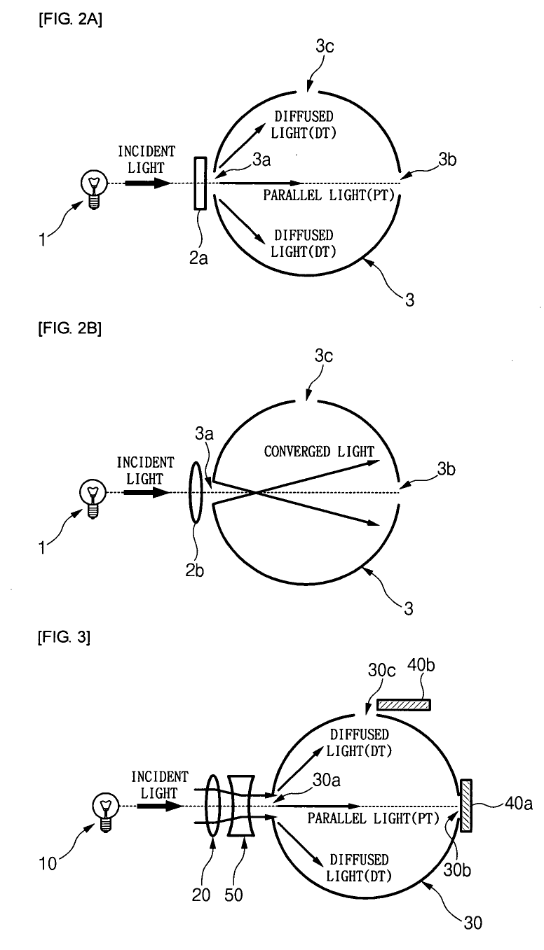

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Hereinafter, preferred embodiments of the present invention will be described in detail with reference to the accompanying drawings.

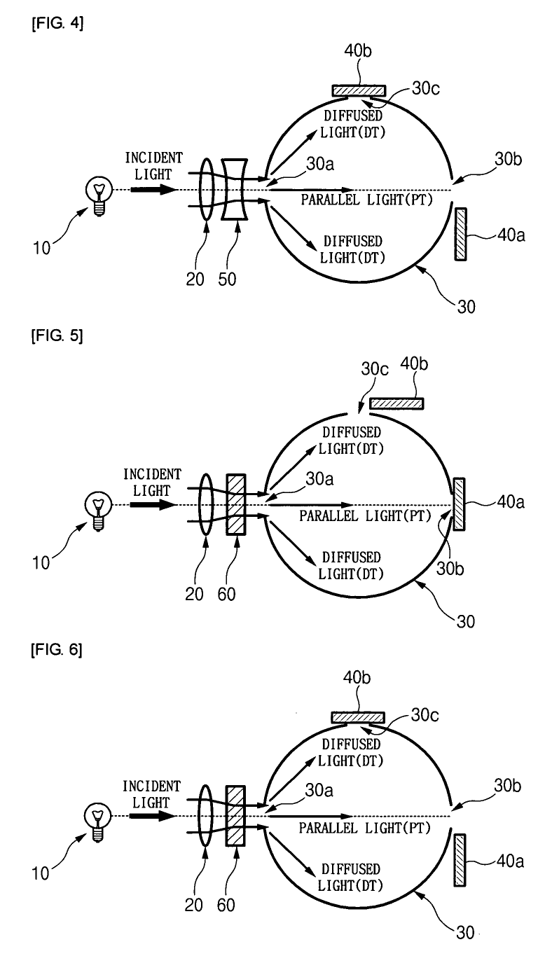

FIGS. 3 and 4 are diagrams for explaining a method of measuring haze according to the present invention. FIG. 3 is a diagram for explaining a method of measuring total transmitted light through a sample, and FIG. 4 is a diagram for explaining a method of measuring diffused light through a sample.

As shown in FIGS. 3 and 4, a haze measuring apparatus according to the invention includes a light source 10 which generates light, a sample 20 with a curved surface on which the light generated by the light source 10 is incident, a null lens 50 which receives the light output from the sample 20 with a curved surface and converts the light into parallel light to output, and a integrating sphere 30 which receives the parallel light output from the null lens 50, separates the parallel light into parallel light PT and diffused light DT, and then detects the separated parallel light PT and diffused light DT so as to measure haze.

As the sample 20 with a curved surface, which is made of a transparent material such as glass or plastic, a glass lens, a plastic lens, a liquid lens and the like can be included. In the present invention, a sample with a plane as well as the sample 20 with a curved surface can be used to measure haze, and samples having other different shapes can be also applied.

The null lens 50 serves to convert the light, converged on and diverged from the sample 20 with a curved surface, into parallel light. When the sample 20 with a curved surface is a convex lens, the null lens 50 is preferably composed of a concave lens. On the other hand, when the sample 20 with a curved surface is a concave lens, the null lens 50 can be composed of a convex lens.

The integrating lens 30 is provided with a first opening 30a which receives the parallel light transmitted through the null lens 50 so as to separate into parallel light PT and diffused light DT, a second opening 30b which is formed in a position opposing the first opening 30a, and a third opening 30c which is formed in a direction orthogonal to the first and second openings 30a and 30b. Further, the second opening 30b is provided with a first sensor 40a which measures the parallel light PT separated through the first opening 30a, and a second sensor 40b which measures the diffused light DT separated through the first opening 30a.

The light generated by the light source 10 is refracted by the convergence and divergence through the sample 20 with a curved surface. Further, the light refracted through the sample 20 with a curved surface is converted into parallel light through the null lens 50, and the parallel light output through the null lens 50 is incident on the first opening 30a of the integrating sphere 30 so as to be separated into parallel light PT and diffused light DT. Accordingly, the integrating sphere 30 detects the parallel light PT and diffused light DT, which are incident thereon, so as to measure haze.

In this case, an expression for calculating the haze is represented by the ratio of the parallel light PT to the diffused light DT as in the following Expression 2, which is the same as in the related art.

$$Haze ( \% ) = \frac{diffused light}{total transmitted light} \times 100 \qquad [ Expression 2 ]$$

Therefore, if the ratio of the parallel light PT to the diffused light DT can be known, it is possible to measure haze from Expression 2.

As shown in FIG. 3, the total transmitted light (or parallel light) PT incident through the first opening 30a of the integrating sphere 30 is measured using the first sensor 40a installed in the second opening 30b of the integrating sphere 30. As shown in FIG. 4, the diffused light DT incident through the first opening 30a of the integrating sphere 30 is measured using the second sensor 40b installed in the third opening 30c of the integrating sphere 30. The standards on measuring the haze of the sample are prescribed in ISO FDIS 14782, as described above.

In the present invention, although a sample of which the haze is desired to be measured is a sample with a curved surface, the haze can be accurately measured using the null lens. That is, although the light generated from the light source is refracted through the sample with a curved surface, the light refracted through the sample with a curved surface is converted into parallel light through the null lens, which makes it possible to measure haze. The parallel light output through the null lens is separated into parallel light PT and diffused light DT while being incident through the first opening of the integrating sphere. Therefore, when the parallel light PT and the diffused light, which are separated inside the integrating sphere 30, are detected by the first and second sensors 40a and 40b as described above, it is possible to easily measure haze through Expression 2.

Accordingly, in the present invention, it is possible to accurately measure haze with respect to samples with any shape.

Next, FIGS. 5 and 6 are diagrams for explaining another method of measuring haze according to the present invention. FIG. 5 is a diagram for explaining a method of measuring total transmitted light through a sample using a liquid lens, and FIG. 6 is a diagram for explaining a method of measuring diffused light through a sample using a liquid lens.

As shown in FIGS. 5 and 6, a haze measuring apparatus according to the present embodiment includes a light source 10 which generates light, a sample 20 with a curved surface on which the light generated by the light source 10 is incident, a liquid lens 60 which receives the light output from the sample 20 with a curved surface and converts the light into parallel light to output, and a integrating sphere 30 which receives the parallel light output from the liquid lens 60, separates the parallel light into parallel light PT and diffused light DT, and then detects the separated parallel light PT and diffused light DT so as to measure haze.

The liquid lens 60 serves to convert the light, converged into or diverged from the sample 20 with a curved surface, into parallel light to output. Further, depending on a type of sample, the liquid lens 60 changes an applied voltage so as to change a curvature, thereby changing a focal distance. That is, the liquid lens 60 can change a focal distance by simply adjusting only an applied voltage, without varying the position in order to adjust a focal distance depending on a material of sample. Therefore, when light refracted in a sample passes through the liquid lens 60, the liquid lens 60 changes a focal distance through an applied voltage regardless of the type of sample, thereby converting the light incident on the integrating sphere 30 into parallel light.

In the present invention, although a sample of which the haze is desired to be measured is a sample with a curved surface such as a lens, the haze can be accurately measured using the liquid lens. That is, although the light generated from the light source is refracted through the sample with a curved surface, the light refracted through the sample with a curved surface is converted into parallel light through the liquid lens 60, which makes it possible to measure haze. The parallel light output through the liquid lens 60 is separated into parallel light PT and diffused light DT while being incident through the first opening of the integrating sphere. Therefore, when the parallel light PT and the diffused light, which are separated inside the integrating sphere 30, are detected by the first and second sensors 40a and 40b as described above, it is possible to easily measure haze through Expression 2.

In the present invention, a collimator which converts light, refracted in a sample, into parallel light can be replaced with the liquid lens 60. Therefore, a collimator does not need to be changed, whenever a type of sample differs. That is, if an applied voltage is changed depending on a sample, the curvature of the liquid lens changes so as to vary a focal distance. Therefore, a collimator does not need to be changed depending on a sample.

Accordingly, in the present invention, it is possible to accurately measure haze with respect to samples with any shape. Further, it is possible to measure haze of all samples using only a liquid lens, without changing a collimator depending on a sample.

According to the method of measuring haze and the apparatus thereof, the null lens or the liquid lens is added between the sample with a curved surface and the integrating sphere such that the light incident on the integrating sphere through the sample is not refracted, which makes it possible to quantitatively measure and evaluate haze regardless of the shape of the sample.

Therefore, it is possible to evaluate the white haze of an injection-molded plastic lens and to standardize an evaluation basis with respect to haze which cannot be seen with naked eyes.

Further, a focal distance is varied by changing an applied voltage depending on a sample using the liquid lens. Therefore, a collimator does not need to be changed whenever a type of sample differs.

Further, it is possible to measure haze in real-time for each voltage when evaluating a liquid lens.

Further, it is possible to measure the haze of a liquid lens, composed of liquid, in a liquid state.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of measuring haze comprising:
transmitting light, generated by a light source, through a sample;
converting the light, transmitted through the sample, into parallel light through a null lens; and
separating the light, transmitted through the null lens, into parallel light and diffused light through an integrating sphere and then measuring haze.

2. The method of measuring haze according to claim 1,
wherein the haze is obtained by the following expression:
$$Haze ( \% ) = \frac{diffused light}{total transmitted light} \times 100.$$

3. The method of measuring haze according to claim 2,
wherein the parallel light is detected by a sensor installed in an opening of the integrating sphere which is formed in a direction where the parallel light is incident.

4. The method of measuring haze according to claim 2,
wherein the diffused light is detected by a sensor installed in an opening of the integrating sphere which is formed in a direction orthogonal to the direction where the parallel light is incident.

5. The method of measuring haze according to claim 1,
wherein, as the sample, any one of a transparent plane sample, a glass lens, a plastic lens, and liquid lens is used.

6. The method of measuring haze according to claim 1,
wherein the sample is a sample with a curved surface.

7. The method of measuring haze according to claim 6,
wherein the sample with a curved surface is a concave lens.

8. The method of measuring haze according to claim 6,
wherein the sample with a curved surface is a convex lens.

9. An apparatus for measuring haze comprising:
a light source that generates light;
a sample that receives the light from the light source and transmits the light;
an integrating sphere that detects the light transmitted through the sample so as to measure haze; and
a null lens that is positioned between the sample and the integrating sphere and converts the light, incident on the integrating sphere through the sample, into parallel light.

10. The apparatus for measuring haze according to claim 9,
wherein the sample is any one of a transparent plane sample, a glass lens, a plastic lens, and liquid lens.

11. The apparatus for measuring haze according to claim 9,
wherein the sample is a sample with a curved surface.

12. The apparatus for measuring haze according to claim 11,
wherein the sample with a curved surface is a concave lens.

13. The apparatus for measuring haze according to claim 11,
wherein the sample with a curved surface is a convex lens.

14. The apparatus for measuring haze according to claim 9,
wherein the integrating sphere includes:
a first opening that receives the light transmitted through the sample;
a second opening that is formed in a position opposing the first opening;
a third opening that is formed in a direction orthogonal to the first and second openings;
a first sensor that is installed in the second opening so as to measure parallel light of the light transmitted through the sample; and
a second sensor that is installed in the third opening so as to measure diffused light of the light transmitted through the sample.

15. An apparatus for measuring haze comprising:
a light source that generates light;
a sample that receives the light from the light source and transmits the light;
an integrating sphere that detects the light transmitted through the sample so as to measure haze; and
a liquid lens that is positioned between the sample and the integrating sphere and converts the light, incident on the integrating sphere through the sample, into parallel light.

16. The apparatus for measuring haze according to claim 15,
wherein, in the liquid lens, an applied voltage is changed depending on a type of sample, and the curvature thereof changes in accordance with the changed voltage, thereby varying a focal distance.

17. The apparatus for measuring haze according to claim 15,
wherein the sample is any one of a transparent plane sample, a glass lens, a plastic lens, and a liquid lens.

18. The apparatus for measuring haze according to claim 15,
wherein the sample is a sample with a curved surface.

19. The apparatus for measuring haze according to claim 18,
wherein the sample with a curved surface is a concave lens.

20. The apparatus for measuring haze according to claim 18,
wherein the sample with a curved surface is a convex lens.
